(19) United States
(12) Patent Application Publication
(10) Pub. No.: US 2005/0102280 A1
(43) Pub. Date: May 12, 2005

(54) Search system, search program, and personal computer

(76) Inventors: Takashige Tanaka, Matsumoto-shi (JP); Tsuneo Kasai, Nagano-ken (JP); Kazuyoshi Nagayasu, Matsumoto-shi (JP)

Correspondence Address: HARNESS, DICKEY & PIERCE, P.L.C., P.O. BOX 828, BLOOMFIELD HILLS, MI, 48303, US

(21) Appl. No.: 10/929,116

(22) Filed: Aug. 27, 2004

(30) Foreign Application Priority Data
Aug. 29, 2003 (JP) 2003-306807
Apr. 12, 2004 (JP) 2004-116794
May 25, 2004 (JP) 2004-154637

(51) Int. Cl. G06F 17/30

(52) U.S. Cl. 707/3

(57) ABSTRACT

A search system is provided. The search system has: an interface unit for starting an interface component corresponding to an installed browser by utilizing a browser function capable of interpreting a script contained in an HTML file, and accessing a search component through the interface component; and a search engine unit started by the search component and adapted to interpret an inputted character string and search for data corresponding to the character string in a database in accordance with the result of the interpretation.

### RELATED APPLICATIONS

This application claims priority to Japanese Patent Application Nos. 2003-306807 filed Aug. 29, 2003, 2004-116794 filed Apr. 12, 2004, and 2004-154637 filed May 25, 2004 which are hereby expressly incorporated by reference herein in their entirety.

### BACKGROUND

1. Technical Field

This invention relates to a search system, a search program, and a personal computer that enables efficient search for desired text data on the basis of an inputted natural language.

2. Background Art

Currently, in various occasions such as intranets and the Internet, a search system is prepared and used frequently.

That is, storage and distribution of texts are carried out popularly and a search system is an important tool for searching for a desired text from many texts.

Conventionally, in most cases of intranets, an HTTP server is started on a public server and search from an HTTP page is performed by utilizing a server side script (for example, ASP, CGI or PHP).

On the other hand, in the case when a user searches for an arbitrary text on a hard disk in a personal computer (PC), specification margins are not large enough to start an HTTP server, or in many cases, an HTTP server is not installed originally.

Therefore, in a search function or the like of a help function, key words contained in texts are extracted in advance by morphological analysis, then an application is started, and a search for a desired text is performed on the basis of the key words (see JP-A-2001-67363).

However, in the above-described search process, the user must start a special application and enter key words into an input section when carrying out the search function. Therefore, the above-described search process has a problem that for a beginner who rarely uses the help function and is not familiar with the help search function, it is not easy to use this function.

Moreover, since key words must be entered in the above-described search process, it has a problem that, for example, it is easy to find the status of a malfunction but it is difficult for a beginner to properly extract words for acquiring desired information and carry out a search in the proper order.

For example, when “the printer does not operate properly”, the user enters a word “printer”. There are plural items under the item of printer, and the user must select one of these items for analyzing the status of malfunction. This operation is difficult for a user who is not familiar with it.

In view of the foregoing status of the art, it is an object of this invention to provide a search system and a search program utilizing a web browser that enables easy searching for a desired text from a character string in a natural language in the form of a question by inputting this character string without using an HTTP server.

### SUMMARY

A search system according to this invention has: an interface unit for starting an interface component corresponding to the type of installed browser by utilizing a browser function capable of interpreting a script contained in a file of HTML format, and accessing a search component through the interface component; and a search engine unit started by the search component and adapted for interpreting an inputted character string and searching for data corresponding to the character string in a database in accordance with the result of the interpretation.

Thus, in the search system according to this invention, a search component is accessed by utilizing an object call (DLL load) function for a script or applet of the browser installed in a personal computer, and a search engine unit is started. Therefore, a search system utilizing a web browser can be constructed without operating an HTTP server.

Moreover, in the search system according to this invention, a question sentence is entered as a character string in a natural language. As in the case of entry of key words to a browser usually used for searching the Internet, the inputted question sentence is analyzed and a search for a desired text corresponding to this question sentence is carried out. Therefore, it is advantageous that even a beginner who is not familiar with the help search function can easily search for a desired text.

Furthermore, in the search system according to this invention, since the description by the interface unit is an HTML script sentence, it can be easily changed. As correspondence to the installed browser is made, the system can be easily transferred by changing the script sentence.

In the search system according to this invention, the interface unit has a search unit for detecting which type of browser is installed, from an installation information unit (registry information for Windows (registered trademark) or preference information for Mac-OS (registered trademark) of a component) stored in an installation storage unit (for example, an installation information storage unit 4 in an embodiment).

In the search system according to this invention, any installed browser can be supported, and even if the type of browser is changed, plural browsers can be supported without re-installing the system or without undertaking a troublesome process such as changing settings.

Thus, in the search system according to this invention, the interface unit detects the type of the browser installed in the personal computer without the user's notice. As the user enters a character string, a search for desired data is easily performed.

In the search system according to this invention, the search unit in the interface unit has a table on which relations between plural browsers and interface components corresponding to the individual browsers are described.

In the search system according to this invention, the interface unit has a judgment unit for extracting from the table an interface component corresponding to the type of browser detected by the search unit.

Thus, in the search system according to this invention, when the type of installed browser is detected from the installation information stored in the installation information storage unit, an interface component corresponding to the detected browser is easily selected from the table, and the selected component can be loaded and used. Therefore, the interface unit can support each of a plurality of different browsers.

In the search system according to this invention, the search unit has: a text database for recording text data of a search object; a morphological analysis dictionary database in which data for morphological analysis is recorded in advance; a morphological analysis unit for performing morphological analysis of a character string inputted from an input unit with reference to the morphological analysis dictionary database so as to extract a word, and specifying an affirmative form or negative form of the word; a search condition preparation unit for preparing a search condition based on information specifying the affirmative form or negative form of the word; and a text search unit for searching for text data matching the search condition from the text database.

In the search system according to this invention, since an affirmative/negative flag is registered to the search database at the time of morphological analysis in text registration, finding a text of totally opposite meaning can be prevented. Particularly at the time of the troubleshooting process, text data having totally opposite meaning is not necessary and therefore desired text data can be efficiently found. Moreover, since text containing synonyms for a word acquired as a result of morphological analysis of a question sentence are searched for, desired text data can be found more easily.

A search program according to this invention is operable in a computer. The search program includes: a process for an interface unit to start an interface component of description corresponding to an installed browser by utilizing a browser function capable of interpreting a script contained in a file of HTML format, and to access a search component through the interface component; and a process for a search engine unit to be started by the search component and to interpret an inputted character string and search for data corresponding to the character string in a database in accordance with the result of the interpretation.

The search program according to this invention includes a script search process to detect which type of browser is installed from installation information stored in a storage unit.

A personal computer according to this invention has: a manual storage unit in which a manual text of HTML format is stored; a browser capable of interpreting a script contained in the manual text; an interface unit for starting an interface component corresponding to the browser and accessing a search component through the interface component; a text database for storing text data of a search object; a search engine unit started by the search component and adapted for interpreting an inputted question sentence and searching for the text data of the search object in accordance with the result of the interpretation; and an installation information storage unit in which information about installed various applications and data is stored.

This invention is a search system for inputting a character string in a natural language into a search condition input section, as in an ordinary search method on the Internet, and searching for a desired text in a user's personal computer, by using a browser having a component call function for Active X (registered trademark) or JAVA (registered trademark) applet or the like held by Internet Explorer (registered trademark) provided in advance in Windows (registered trademark) or the like. In this case, a search engine performs morphological analysis of the inputted character string and extracts a necessary key word (search condition).

The component, such as Active X or JAVA (registered trademark) applet transmits the key word and the result of the search between a script contained in a file of HTML format having a function of starting the search process and the search engine unit for performing the search (that is, the search engine unit started by the search component). That is, in this invention, the process to start a natural language search and transmission of data are carried out between the script contained in the file of HTML format and the search engine unit, using the browser function previously installed in the personal computer.

### BRIEF DESCRIPTION OF THE DRAWINGS

FIG. 1 is a block diagram showing an exemplary structure of the search system according to an embodiment of this invention.

FIG. 2 is a block diagram showing an exemplary structure of the search engine unit 5 of FIG. 1.

FIG. 3 is a flowchart for explaining an operation of starting a manual file of HTML format.

FIG. 4 is a flowchart showing an example of a search component loading operation (starting the search engine unit 5).

FIG. 5 is a flowchart showing an example of a search operation by the search engine unit 5.

FIG. 6 is a flowchart showing an example of the process to install the search system of FIG. 1 into a computer.

FIG. 7 is a block diagram showing a structure in a personal computer according to an embodiment of this invention.

### DETAILED DESCRIPTION

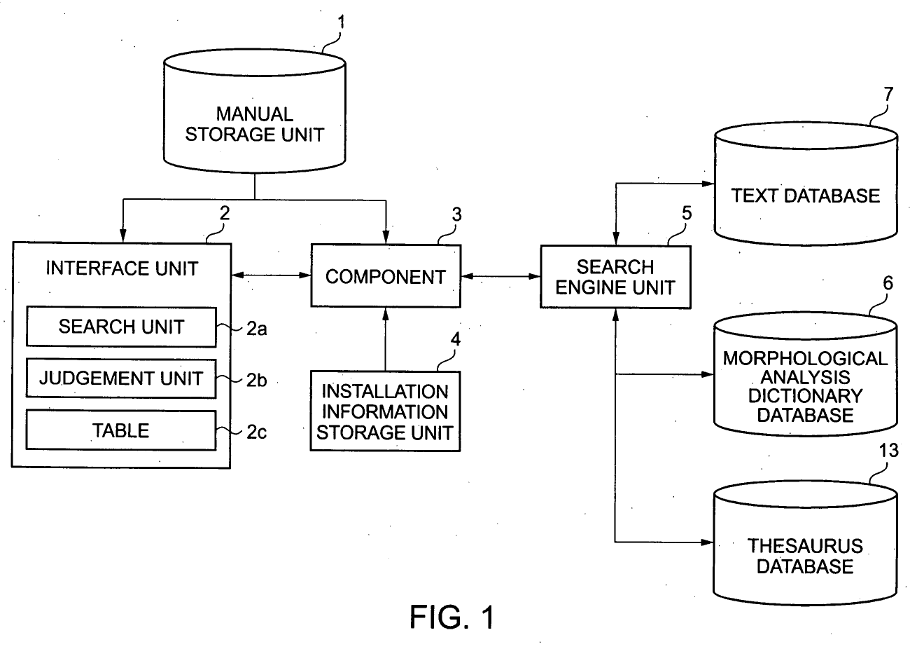

Hereinafter, a search system according to an embodiment of this invention will be described with reference to the drawings. FIG. 1 is a block diagram showing the structure of the embodiment. In a manual storage unit 1, a manual such as an operating manual of an external device (for example, printer, scanner, CRT (cathode ray tube) or the like) connected to a personal computer (PC) is described by HTML and stored.

When the manual is selected, a browser set in advance in the personal computer for reading a file of HTML format is started and this browser interprets and executes a script text of the manual. An interface unit 2 is thus started. As the interface unit 2 is started, it uses an execution interface function to access a component 3 (hereinafter referred to as interface component) described in accordance with the description format (command format), which is a browser, and then starts this component. The interface function processes the script text for accessing the interface component described in the manual by HTML.

The component 3 similarly starts the interface component, accesses DLL (search component) for starting a search engine unit 5, and carries out transmission of data (character string of question sentence and result of search) between the started search engine unit 5 and the interface unit 2. The interface unit 2 has a search unit 2a for retrieving the type of search browser from an installation information storage unit 4, a judgment unit 2b for judging whether the retrieved search browser can be used by a table 2c or not, and the table 2c showing the relation between each search browser and the interface component corresponding to each search browser.

The interface component is described in the command format of the corresponding browser. For example, in the case of Windows (registered trademark), the interface component is described in a format corresponding to Active X (registered trademark) held by Internet Explorer (registered trademark). Alternatively, it is described in a format corresponding to JAVA (registered trademark) applet. The interface component has a function of accessing the search component that starts the search engine unit 5, which will be described later. In the installation information storage unit 4, information regarding applications installed in the personal computer, and directory information of the component of the search engine unit 5, a text database 7, a morphological analysis dictionary database 6 and a thesaurus database 13, are stored.

The interface component is described with contents corresponding to each search browser and has the function of accessing the search component, as described above. Here, the search browser is a browser that has a browser function such as Active X (registered trademark) of Internet Explorer (of Windows (registered trademark) system) or the like, or JAVA (registered trademark) applet (of Macintosh (registered trademark)), installed together with an operating system (OS), and that can interpret an HTML text and describe a script text for accessing DLL by HTML.

Other than the above-described types of browsers, other browsers that can be accessed by an HTML script text and that can access DLL by an HTML script text can also be used, though not installed at the time of installing the OS. Hereinafter, the other browsers, Active X (registered trademark) and JAVA (registered trademark) applet are generally referred to as search browsers.

The search engine unit 5 performs morphological analysis of an inputted character string by using the morphological analysis dictionary database 6 and thus extracts a key word. In the morphological analysis dictionary database 6, dictionary data for morphological analysis of texts are recorded. The search engine unit 5 also searches for desired text data corresponding to a character string, that is, a question sentence, by the keyword search in the text database 7, and outputs the result of the search. In the text database 7, plural text data of search objects are recorded.

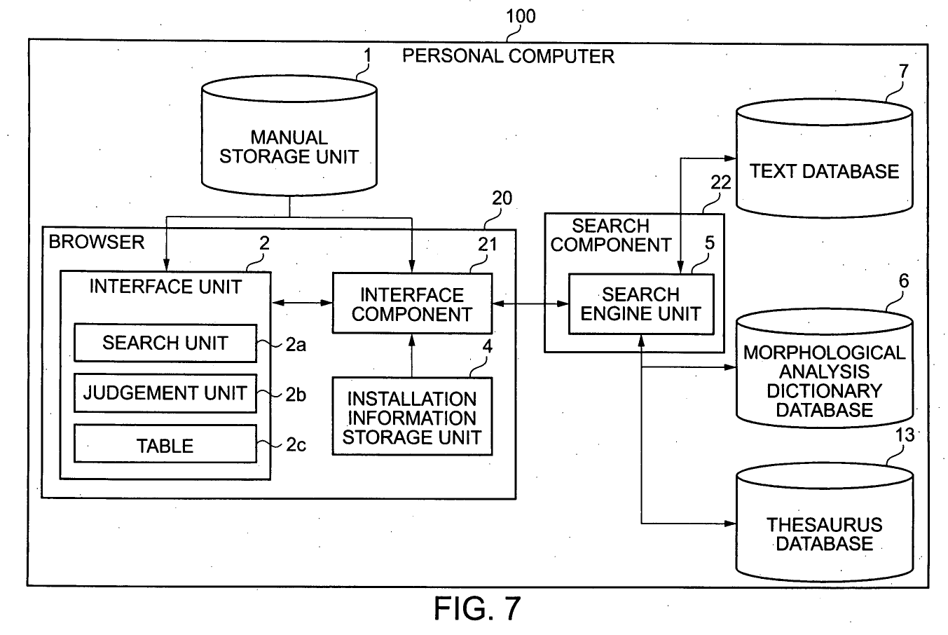

FIG. 7 shows a block structure in the personal computer of the above-described embodiment. FIG. 7 shows the relation between each element of the search system shown in FIG. 1, a browser 20, an interface component 21 and a search component 22, in a personal computer 100.

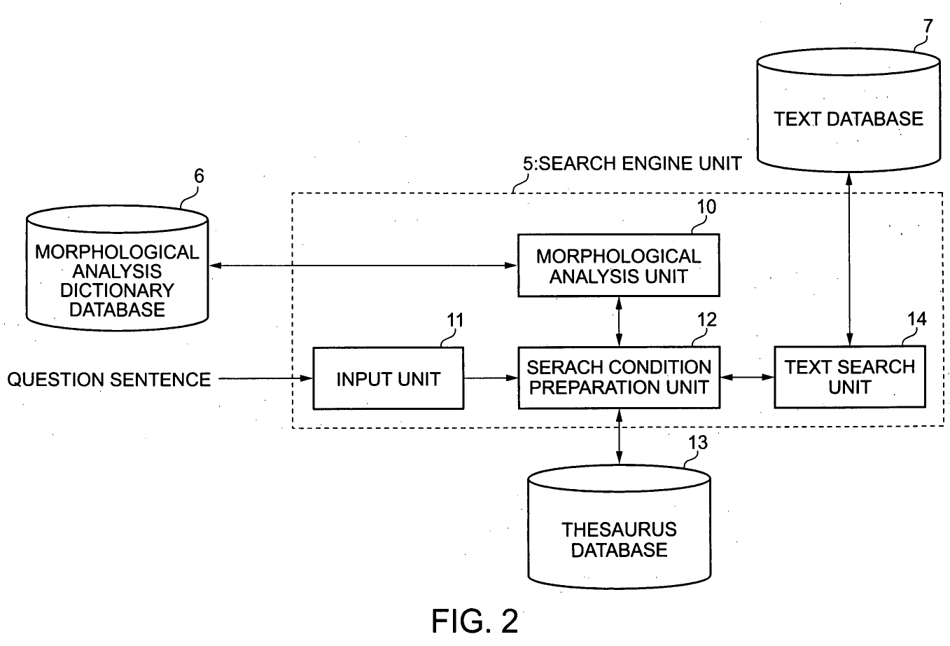

Next, the structure of the search engine unit 5 will be described with reference to FIG. 2. FIG. 2 is a block diagram showing an exemplary structure of the search engine unit 5. In FIG. 2, the text database 7, the morphological analysis dictionary database 6 and the thesaurus database 13 are the databases shown in FIG. 1.

A morphological analysis unit 10 performs morphological analysis of a character string of a question sentence inputted through an input unit 11, with reference to the morphological analysis dictionary database 6. The input unit 11 is an input unit for inputting a character string of a question sentence for finding desired text data, from the component 3. A search condition preparation unit 12 prepares a search condition (key word) from the character string in order to efficiently search for an answer to the question sentence inputted through the input unit 11. As the search condition, for example, the search condition preparation unit 12 finds a synonym for a word acquired as a result of morphological analysis of the question sentence with reference to the thesaurus database 13. In the thesaurus database 13, synonyms are associated and recorded with each word that is frequently used. A text search unit 14 performs search according to the search condition prepared by the search condition preparation unit 12.

In the text database 7, the association of a word and a text corresponding to the word is stored divisionally into an index part and a data part. That is, in the index part, a part of a word, and leading addresses in the data part of a group of words containing this part of the word, are associated and described. In the data part, all the data of the word and text addresses indicating addresses where texts containing this word are stored for each group of words containing part of the word. The text data of the texts are stored in another area.

Therefore, since the text search unit 14 searches for a text in the data unit, at the address acquired in the index part, as will be described later, the text search unit 14 can perform high-speed searching for text based on a word from the text database 7.

Moreover, as morphological analysis of a sentence is performed, independent words and appending words can be acquired and also inflections of the individual words can be acquired. In this embodiment, words are classified into verbs, adjectives, adjectival verbs, and nouns at the time of registration to the text database 7. The parts of speech of inflections (parts of speech of appending words) are not registered in principle. However, an “affirmative/negative flag” is provided for each of adjectives, adjectival verbs, verbs and the like. In the case of “affirmation”, the “affirmative/negative flag” is set at 0. In the case of “negation”, the “affirmative/negative flag” is set at 1.

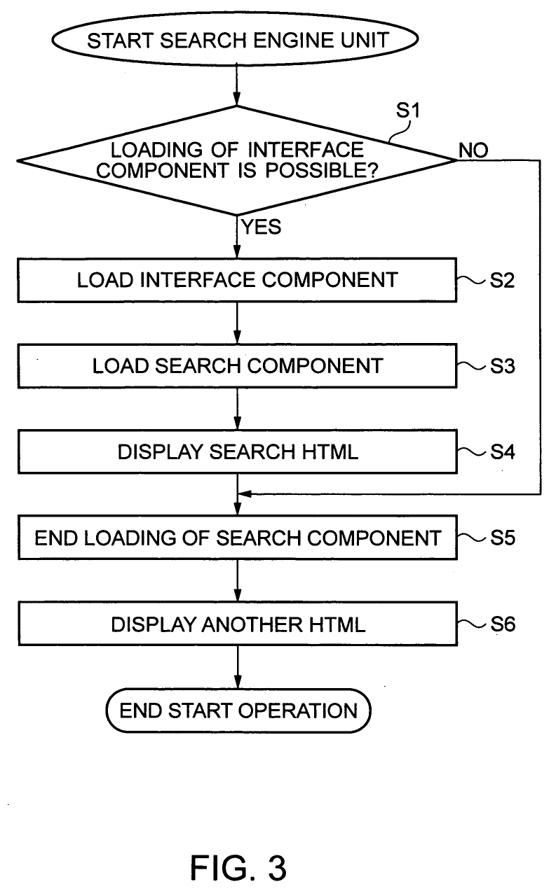

Next, an exemplary operation of loading a search component according to one embodiment and starting the search engine unit 5 will be described with reference to FIGS. 1, 2 and 3. FIG. 3 is a flowchart showing the operation of starting the search engine unit 5. In the following description, a process to retrieve a printer manual is described as an exemplary operation in the search system.

A user uses a mouse to click an icon of a printer manual of HTML format installed in advance in the personal computer and displayed on the CRT screen. This starts the browser capable of interpreting HTML loaded on the personal computer. The browser interprets an HTML script text of the printer manual and the interface unit 2 is started. This starts the process to load the search component.

Next, the search unit 2a in the interface unit 2 retrieves the identification of the browser installed in the personal computer from the installation information storage unit 4. Then, the judgment unit 2b judges whether this browser is set as a search browser or not.

At this point, if the judgment unit 2 detects that the browser retrieved from the installation information storage unit 4 is set in the table 2c as a search browser, the judgment unit 2b determines that the search engine unit 5 is available for use (the interface component can be loaded), and the process goes to step S2. On the other hand, if the judgment unit 2b detects that the browser retrieved from the installation information storage unit 4 is not set in the table 2c as a search browser, the judgment unit 2b determined that the search engine unit 5 is not available for use, and the process goes to step S5. (This processing is at step S1.)

Next, the interface unit 2 loads the interface component that is judged to be available for use from a predetermined DLL storage area, then unfolds it on the memory, and starts the search component, that is, the component 3. The browser started in this manner has been installed at the time of installing the OS. If the OS is Windows (registered trademark), the browser is Active X (registered trademark) or JAVA (registered trademark) applet. If the OS is Mac-OS-X (registered trademark), the browser is one from the JAVA (registered trademark) applet group. (This processing is at step S2.)

The component 3 has a function of accessing the search component of the search engine unit 5 (that is, a function of accessing the search component of the search engine unit 5 based on the description of an HTML script text). The component 3 retrieves the search component from the DLL storage area, loads and unfolds it on the memory, and starts the search engine unit 5 (step S3). Thus, the component 3 displays on the CRT screen a search window including an input section to which a character string of a question sentence used for search is inputted (step S4) and ends the start process of the search engine unit 5 (step S5). Then, the interface unit 2 displays other HTML expressions such as the cover of the printer manual, in a part adjacent to the search window (step S6). As this is done, the interface unit 2 ends the loading of the printer manual from the manual storage unit 1.

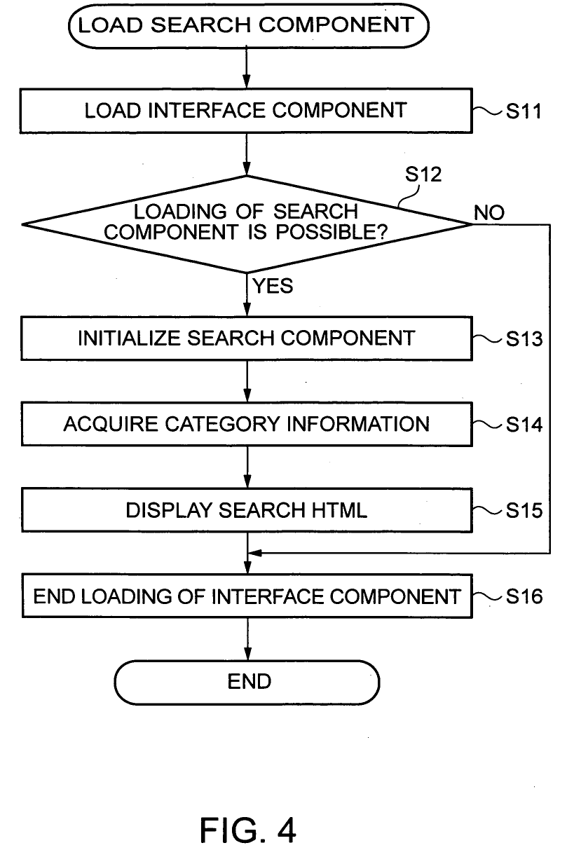

Next, the operation of loading the search component by the component 3 will be described with reference to FIG. 4. FIG. 4 is a flowchart showing an example of the search component loading operation (corresponding to steps S2 and S3 in FIG. 3) by the component 3.

The interface unit 2 loads the interface component of the component 3, and the component 3 is started (step S11). As the component 3 is started, it is judged whether loading of the search component is possible or not, by a process described by an HTML script text. If loading is possible, the search component is loaded and the process goes to step S13. If loading is not possible, the process goes to step S16. That is, display of search HTML is skipped (This processing is at step S12).

Next, when the search component is loaded and the search engine unit 5 is thus started, the component 3 reads out the directory information of the morphological analysis dictionary database 6, the text database 7, the thesaurus database 13 and the like from the installation information storage unit 4, and performs initialization necessary for the search process in the search engine unit 5 (step S13). Then, the component 3 acquires a search category to be displayed on the search HTML, for example, from the manual storage unit 1 (step S14). This search category is formed by classification depending on the type of text of a search target, in order to narrow the search range. For example, for the printer manual, categories such as “printing method,” “trouble,” and “software” are prepared.

Next, the component 3 displays the search window including the input section to which a question sentence for the search is inputted and a selection part for selecting the search category, on the CRT screen (step S15). Then, the interface unit 2 ends the loading of the interface component of the component 3, and the component 3 ends the initialization of the search engine unit 5 (step S16).

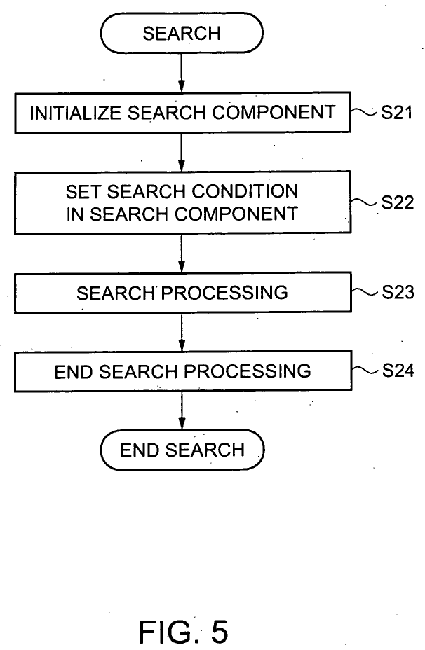

Next, the operation of the search process carried out by the search engine unit 5 will be described with reference to FIG. 5. FIG. 5 is a flowchart showing an exemplary operation of a search process by the search engine unit 5.

As described at step S13 in FIG. 4, initialization necessary for the search process by the search engine unit 5 is carried out (step S21). The search engine unit 5 acquires a search category from the selection part, thus narrowing the range of search objects, then performs morphological analysis of a character string inputted from the interface unit 2 through the component 3, and performs analysis and extraction of a search condition (step S22).

That is, at step S22, the input unit 11 reads the inputted question sentence. In this embodiment, it is assumed that a character string “the printer does not operate properly” is inputted. The input unit 11 sends the inputted character string to the search condition preparation unit 12. Next, the search condition preparation unit 12 sends the received question sentence to the morphological analysis unit 10. Having received this question sentence, the morphological analysis unit 10 performs morphological analysis of the received question sentence with reference to the morphological analysis dictionary database 6. As the result of this analysis, “noun: printer” and “verb: operate (negative form)” are acquired.

Then, the morphological analysis unit 10 sends back the acquired result of the analysis to the search condition preparation unit 12.

Next, the search condition preparation unit 12 prepares a search condition based on the result of the morphological analysis. In this embodiment, the search condition is “noun: printer & verb: operate (negative/affirmative flag=1)”. The search condition preparation unit 12 sends the prepared search condition to the text search unit 14.

At step S23, the text search unit 14 searches the text database 7, using the search condition received from the search condition preparation unit 12 (step S23). As the result of this search, the text search unit 14 acquires page ID of text data containing the noun “printer” and also containing the verb “operation (negative form)” from the text database 7. If there are plural text data that meet the search condition, the text search unit 14 acquires plural page IDs. Then, the text search unit 14 notifies the search condition preparation unit 12 of the completion of search. Then, the search condition preparation unit 12 rearranges the page IDs of the result of the search by the text search unit 14, in the order of text data on the basis of preset degree of importance, weighting value, or order of titles (for example, order of the Japanese syllabary or alphabetical order), and then outputs the rearranged result of the search to the text search unit 14 (step S24). Next, the interface unit 2 displays the text of the rearranged result of the search inputted from the text search unit 14, on a CRT or the like through the component 3.

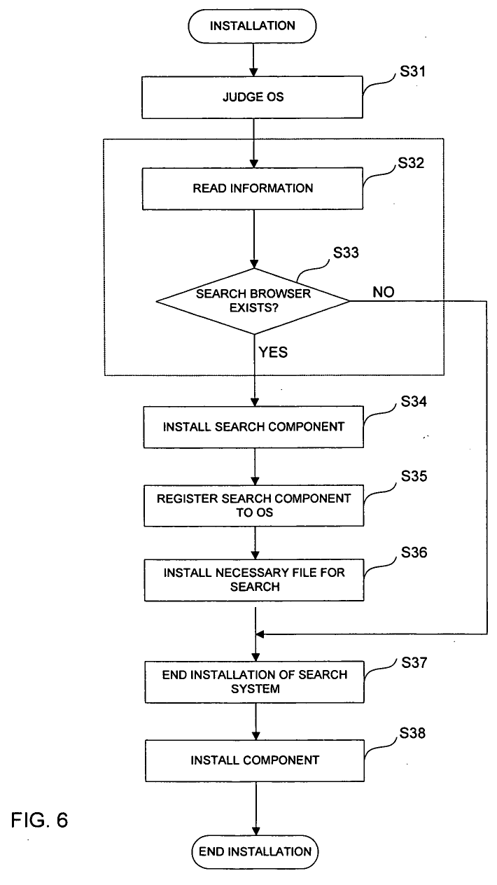

Next, a process to install the search system according to this invention to a personal computer will be described. FIG. 6 is a flowchart for explaining an exemplary operation of installation. The installation is performed using a CD-ROM (compact disc read-only memory) on which an installation program and files necessary for the search system are stored.

As the user starts the installation process, the installer is unfolded and started on the memory of the personal computer. This installer (installation unit) judges the type of OS installed in the personal computer, for example, Windows (registered trademark) or Mac-OS (registered trademark) (step S31).

Next, the process shifts to installation of the search component. In the case of the structure of the interface unit 2 shown in FIG. 1, when the interface unit 2 is started, the type of the installed search browser is detected and the call DLL corresponding to this search browser is used. Therefore, since retrieval and judgment of the search browser need not be carried out, steps S32 and S33 are skipped and these steps are not executed in the installation operation. That is, the installer shifts the process from step S31 to step S34 and performs a process to install the search component.

For example, if the installer detects that the OS is Windows (registered trademark) at step S31, the installer associates a search component corresponding to Active X (registered trademark) in Internet Explorer (registered trademark), a search component corresponding to JAVA (registered trademark) applet and the like with the types of individual search browsers and installs the search components in the form of the table 2c of the interface unit 2 (step S34).

Then, the installer registers all the installed types of search components to the installation information storage unit 4 (step S35). Next, the installer installs other files to be used for search, that is, files in the search unit 2a and the judgment unit 2b of the interface unit 2, the component of the search engine unit 5, the morphological analysis dictionary database 6 and the text database 7 (step S36). This ends the installation process (step S37). Then, the installer installs files or the like of the printer manual (step S38).

On the other hand, in the case of installing a search component corresponding to a search browser that is installed in advance, unlike the structure of the interface unit 2 of FIG. 1, the process of steps S32, S33 in FIG. 6 is executed.

After the type of the OS is detected at step S31, the installer detects which search browser is installed, in the installation information storage unit 4 (step S32).

When a search browser is detected, the installer shifts the process to step S34. If no search browser is detected, the installer shifts the process to step S37 (step S33). Next, the installer installs a search component corresponding to the search browser (step S34). The subsequent process is similar to the process of steps S35 to S38, which is already described above. At step S37, in the interface unit 2 where installation is carried out, the files of the search unit 2a, the judgment unit 2b and the table 2c do not exist, and only a function of loading the installed search component is installed without retrieving the installed search browser.

The search process in the search system may also be performed by recording a program for realizing the function of the processing unit in FIG. 1 onto a computer-readable recording medium and then causing a computer system to read and execute the program recorded on the recording medium. The “computer system” in this case includes an OS and hardware such as peripheral devices. The “computer system” also includes a World Wide Web system having a homepage providing environment (or display environment). The “computer-readable recording medium” is a portable medium such as a flexible disk, magneto-optical disc, DVD-ROM or CD-ROM, or a storage device such as a hard disk arranged in a computer system. Moreover, the “computer-readable recording medium” includes a recording medium that holds a program for a predetermined time, such as a volatile memory (RAM) within a computer system, which serves as a server or client when the program is transmitted through a network such as the Internet or a communication channel such as a telephone line.

The program may be transmitted from a computer system having this program stored in its storage device or the like to another computer system through a transmission medium or through transmission waves in the transmission medium. In this case, the “transmission medium” transmitting the program is a medium having a function of transmitting information, such as a network (communication network) like the Internet or a communication channel (communication line) like a telephone line. The program may be for realizing a part of the above-described functions. The program may be a program that can realize the above-described functions in combination with a program that is already recorded in a computer system, that is, a differential file (differential program).

1. A search system comprising:
an interface unit for starting an interface component corresponding to an installed browser by utilizing a browser function adapted to interpret a script contained in an HTML file, and accessing a search component through the interface component; and
a search engine unit started by the search component and adapted to interpret an inputted character string and search for data corresponding to the character string in a database in accordance with the result of the interpretation.

2. The search system as claimed in claim 1, wherein the interface unit includes a search unit for detecting an identity of the installed browser from installation information stored in an installation storage unit.

3. The search system as claimed in claim 1, wherein the interface unit includes a table describing relations between plural browsers and interface components corresponding to the individual browsers.

4. The search system as claimed in claim 3, wherein the interface unit includes a judgment unit for extracting from the table an interface component corresponding to the installed browser detected by the search unit.

5. The search system as claimed in claim 1, wherein the search unit includes:
a text database for recording text data of a search object;
a morphological analysis dictionary database in which data for morphological analysis is pre-recorded;
a morphological analysis unit for performing morphological analysis of a character string inputted from an input unit with reference to the morphological analysis dictionary database so as to extract a word, and specifying at least one of an affirmative form and a negative form of the word;
a search condition preparation unit for preparing a search condition based on information specifying the at least one of the affirmative form and negative form of the word; and
a text search unit for searching for text data matching the search condition from the text database.

6. A search program that can be executed by a computer, the program comprising:
a process for an interface unit to start an interface description component corresponding to an installed browser by utilizing a browser function adapted to interpret a script contained in an HTML file, and to access a search component through the interface component; and
a process for a search engine unit to be started by the search component and to interpret an inputted character string and search for data corresponding to the character string in a database in accordance with the result of the interpretation.

7. The search program as claimed in claim 6, wherein the interface process includes a process to detect an identity of the installed browser from installation information stored in an installation information storage unit.

8. A personal computer comprising:
a manual storage unit in which an HTML format manual text is stored;
a browser adapted to interpret a script contained in the manual text;
an interface unit for starting an interface component corresponding to the browser and accessing a search component through the interface component;
a text database for storing text data of a search object;
a search engine unit started by the search component and adapted to interpret an inputted question and search for the text data of the search object in accordance with the result of the interpretation; and
an installation information storage unit in which information about installed applications and data is stored.

9. The personal computer as claimed in claim 8, wherein the interface unit includes a search unit for detecting an identity of the browser that is installed in the computer from the information stored in the installation storage unit.

10. The personal computer as claimed in claim 8, wherein the interface unit includes a table describing relations between plural browsers and interface components corresponding to the individual browsers.

11. The personal computer as claimed in claim 10, wherein the interface unit includes a judgment unit for extracting from the table an interface component corresponding to the browser detected by the search unit.

12. The personal computer as claimed in claim 8, further comprising:
a morphological analysis dictionary database in which data for morphological analysis is recorded in advance; and
a thesaurus database in which a synonym for each frequently used word is associated and stored with each word, wherein the search engine unit includes:
a morphological analysis unit for analyzing the question with reference to the morphological analysis dictionary database so as to extract a word, and specifying at least one of an affirmative form and a negative form of the word;
a search condition preparation unit for preparing a search condition including a synonym for the word extracted by analyzing the question, with reference to the thesaurus database; and
a text search unit for searching for a text matching the search condition from the text database.
